(19) United States
(12) Patent Application Publication
(10) Pub. No.: US 2013/0325349 A1
(43) Pub. Date: Dec. 5, 2013

(54) Methods for Generating Depofacies Classifications for Subsurface Oil or Gas Reservoirs or Fields

(71) Applicants: Ivana Bunting, Houston, TX (US); Clive Dodman, Houston, TX (US)

(72) Inventors: Ivana Bunting, Houston, TX (US); Clive Dodman, Houston, TX (US)

(73) Assignee: Chevron U.S.A. Inc., San Ramon, CA (US)

(21) Appl. No.: 13/485,566

(22) Filed: May 31, 2012

(51) Int. Cl. G01V 9/00; G06F 17/00

(52) U.S. Cl. CPC G01V 9/00; G06F 17/00
USPC 702/11

(57) ABSTRACT

Described herein are embodiments of a method for generating a refined depofacies classification corresponding to a subsurface reservoir. The method includes analyzing a plurality of rock cores obtained from a plurality of wells drilled in the reservoir or field, analyzing a plurality of well logs comprising a plurality of different well log types obtained from the plurality of wells, and determining an initial depofacies classification for at least portions of the oil or gas reservoir or field. It is then determined whether at least one diagenetic, heavy, light or anomalous mineral is present in some of the analyzed rock cores, and if so, whether at least one well log type from among the plurality of different well log types is capable of substantially accurately identifying the presence of the mineral present. The initial depofacies classification is re-analyzed and reclassified to produce a refined depofacies classification.

### FIELD

Various embodiments described herein relate to the field of petrophysical rock type determination, analysis and classification, oil and gas reservoir characterization, and methods and systems associated therewith.

### BACKGROUND

The prediction of petrophysical facies from well log data, where the predicted petrophysical facies are consistent with rock core descriptions, has been a continuing challenge in the field of petrophysics. For example, multiple iterations of predicted petrophysical facies in an oil or gas reservoir or field sometimes do not produce facies that reliably or accurately represent regional stratigraphic continuities. Faithful representations of petrophysical properties in petrophysical facies are required to create static models, facies and permeability estimates that can be used for subsequent dynamic modeling with minimal or no adjustments. Thus, well log properties and petrophysical facies are critical inputs to the static model. If the predicted petrophysical facies inputs to the static model are inaccurate, the resulting model will be inaccurate. In addition, accurate adjustment and calibration of sonic well logs from a given oil or gas field or reservoir is made more difficult when predicted petrophysical facies are inaccurate or unreliable.

Another factor complicating the accurate prediction or determination of petrophysical facies in oil or gas fields or reservoirs is that many known reserves of oil and gas are found in carbonate formations that have undergone diagenesis. To optimize production from such reserves, petroleum engineers must understand the physical properties of carbonate formations, including the porosity and permeability properties associated therewith. In many geological formations, such physical properties are determined primarily in accordance with the manner in which such formation were known to have been deposited initially, and are then modified to some extent by factors associated with pressure and heat. It is therefore possible to describe and classify such geological formations in terms of their depositional environments, with some acknowledgement of subsequent changes to physical properties.

Carbonates, however, present an unusual challenge in that their properties may be greatly modified, at least with respect to the rock in its original state, and the rock types associated therewith changed significantly, by diagenesis. In particular, pore structures may be very different from those characterized by original depositional environments. Carbonates can also exhibit secondary porosity, where diagenetic processes create larger scale pores or “vugs”. In some carbonates such vugs are connected, and in other carbonates they are not. These additional factors can significantly influence the flow of fluids through the carbonate formations. If the carbonate formation have not been modified by diagenesis, the dynamic or flow properties may be those of the rocks as they were originally deposited and controlled largely by pore types related to the initial texture of the rocks. If the carbonates have been modified by diagenetic processes, however, their dynamic properties may be controlled by a combination of primary porosity and secondary porosity.

The foregoing and other factors can result in resolution differences between well logs and rock cores (which can introduce inconsistencies in resulting petrophysical facies or reservoir models), facies models being created with the latest technology that are not consistent with depositional sequences, predicted petrophysical facies matching rock cores reasonably well but lacking sufficient continuity across a field or reservoir model, predicted petrophysical facies having insufficient resolution to permit accurate reservoir modeling, and velocity models in the field or reservoir exhibiting random positioning errors and poor or inadequate adjustments for velocity anisotropy.

Among other things, improved methods of accurately and reliably predicting the petrophysical facies associated with oil and gas fields or reservoirs, especially when carbonate formations that have undergone diagenesis are under present, are required.

### SUMMARY

According to one embodiment, there is provided a method of generating a refined depofacies classification corresponding to a subsurface oil or gas reservoir or field comprising analyzing a plurality of rock cores obtained from a plurality of wells drilled in the reservoir or field, analyzing a plurality of well logs comprising a plurality of different well log types, the well logs having been obtained from the plurality of wells, on the basis of the rock core and well log analyses, determining an initial depofacies classification for at least portions of the oil or gas reservoir or field, determining whether at least one diagenetic, heavy, light or anomalous mineral is present in at least some of the analyzed rock cores, if at least one diagenetic, heavy, light or anomalous mineral is detected in at least some of the analyzed rock cores, determining at least one well log type from among the plurality of different well log types that is capable of substantially accurately identifying a presence of the at least one diagenetic, heavy, light or anomalous mineral in a well bore, and re-analyzing and reclassifying the initial depofacies classification on the basis of the rock core analyses, the well log analyses, the diagenetic, heavy, light or anomalous mineral detection, and the at least one determined well log type to generate a refined depofacies classification for at least portions of the oil or gas reservoir or field.

Further embodiments are disclosed herein or will become apparent to those skilled in the art after having read and understood the specification and drawings hereof.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

Different aspects of the various embodiments of the invention will become apparent from the following specification, drawings and claims in which:

FIG. 1 shows one embodiment of a Venn diagram 102 illustrating a multidisciplinary approach to generating petrophysical facies;

FIG. 2 shows one embodiment of a method 200 for generating a refined depofacies classification corresponding to a subsurface oil or gas reservoir or field;

FIG. 3 shows one embodiment of a facies and permeability modeling workflow 300 for generating a refined depofacies classification corresponding to a subsurface oil or gas reservoir or field;

FIG. 4 shows an exemplary porosity vs. permeability graph for a representative hydrocarbon reservoir;

FIG. 5 shows dolomite content and porosity vs. permeability graph 500, and the effects of dolomite on porosity and permeability;

FIG. 6 shows a lithofacies model 600 based on data obtained from the same 30 wells as were employed to generate the porosity vs. permeability cross-plot of FIG. 4;

FIG. 7 shows a depositional facies model 700 based on data obtained from the same 30 wells as were employed to generate the porosity vs. permeability cross-plot of FIG. 4;

FIG. 8 shows the results of an iterative and geologically upscaled depositional facies model 800 generated using data corresponding to a single blind test well;

FIG. 9 shows results obtained for the blind test well of FIG. 8, where a new permeability model was constructed with improved depositional and lithofacies;

FIGS. 10(a), 10(b) and 10(c) compare and contrast “old,” “new” and core cross-plotted permeability vs. porosity data;

FIGS. 11(a) and 11(b) represent predicted ranges of permeability for the two best reservoir facies of the 30 wells described above in connection with FIGS. 4 through 10(c);

FIGS. 12(a) and 12(b) show predicted reservoir permeabilities across a representative oil field computed in accordance with the new techniques described and disclosed herein, and

FIG. 13 shows exemplary oil and water history production curves for a representative oil field.

The drawings are not necessarily to scale. Like numbers refer to like parts or steps throughout the drawings, unless otherwise noted.

### DETAILED DESCRIPTIONS OF SOME EMBODIMENTS

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple computer processors, hand-held devices, programmable consumer electronics, mini-computers, mainframe computers, and the like. The invention may also be practiced in distributed computing environments where tasks are performed by servers or other processing devices that are linked through a one or more data communications network. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

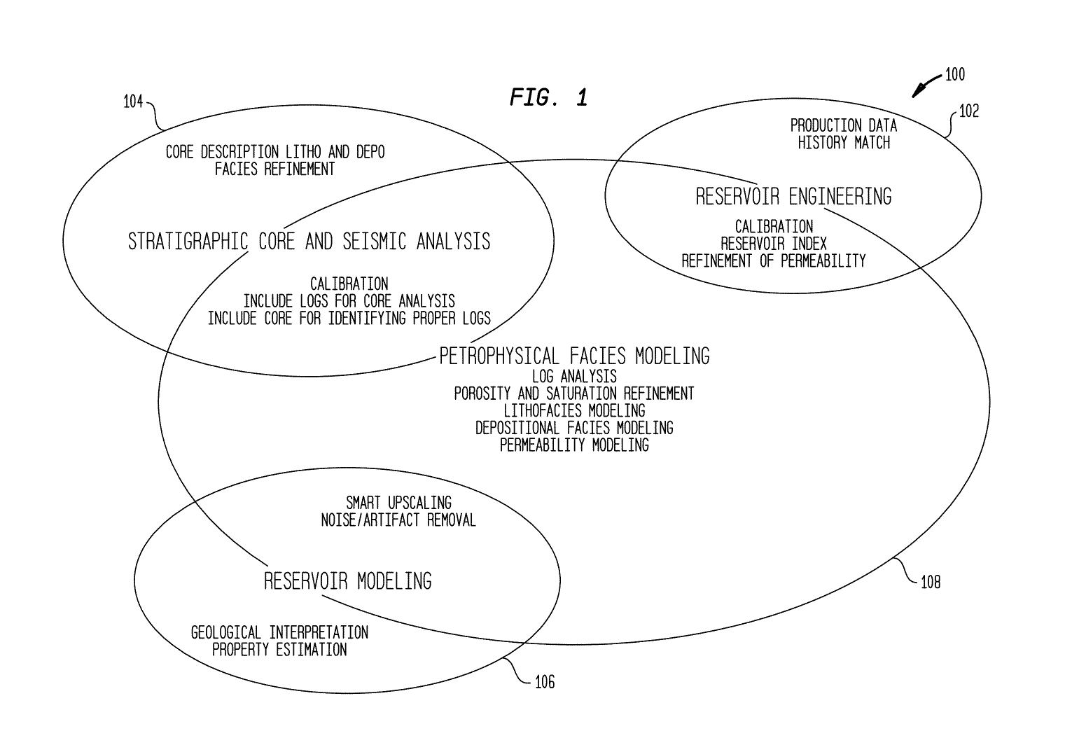

FIG. 1 shows one embodiment of a Venn diagram 102 illustrating a multidisciplinary approach to generating petrophysical facies. In FIG. 1, several different fields of knowledge and expertise are shown to intersect with petrophysical facies modeling 108. As shown, inputs from reservoir engineering field 102, stratigraphic core and seismic analysis field 104, and reservoir modeling field 106 are combined to predict petrophysical facies. For example, log analyses, porosity and saturation refinement, lithofacies modeling, depositional facies modeling, and permeability modeling may be carried out in petrophysical facies modeling field 108 using selected inputs from reservoir engineering field 102, stratigraphic core and seismic analysis field 104, and reservoir modeling field 106.

Regions where the various fields 102, 104 and 106 intersect with petrophysical modeling 108 represent the integration of data and knowledge from, and results provided by, the different fields. Where reservoir engineering 102 overlaps with and intersects petrophysical modeling 108, for example, production data and history matches may be provided as inputs to petrophysical facies modeling 108, which may then be used, by way of illustrative example, to calibrate reservoir production data, generate reservoir indexes, or refine estimates of reservoir permeability. Where reservoir stratigraphic core and seismic analysis 104 overlaps with and intersects petrophysical modeling 108, rock core descriptions may be employed to generate lithofacies and depofacies, which may then be provided, by way of illustrative example, as inputs to petrophysical facies modeling 108 to calibrate stratigraphic core and seismic data, combine and accurately correlate well log and core data, and/or identify the best well log types to use in certain aspects of petrophysical modeling (e.g., accurate determination or detection of the presence of diagenetic minerals (e.g., dolomite), heavy minerals (e.g., iron carbonate or pyrite), anomalous minerals (e.g., marcasite), or light minerals (e.g., feldspars such as albite). Where reservoir modeling 106 overlaps with and intersects petrophysical modeling 108, geological interpretation and reservoir property estimates may be provided as inputs, by way of illustrative example, to petrophysical facies modeling 108 to upscale data and remove noise and artifacts from data (more about which is said below). It is to be noted that inputs, intersections and results other than those shown explicitly in FIG. 1 or described above are also contemplated.

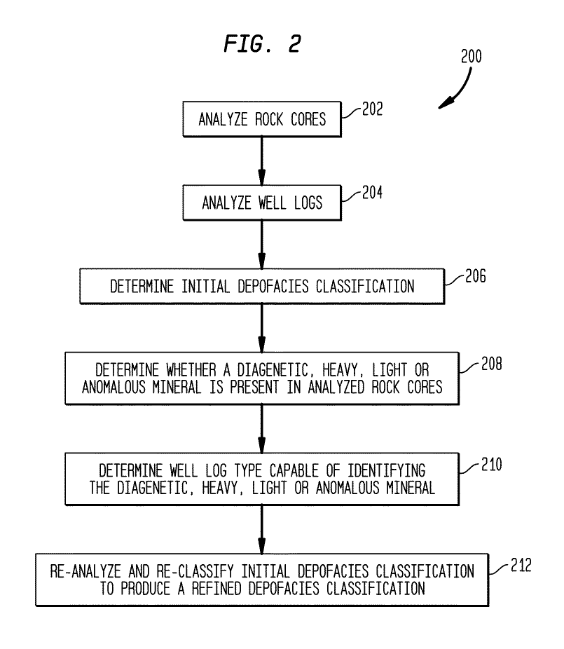

Referring now to FIG. 2, there is shown one embodiment of a method 200 for generating a refined depofacies classification corresponding to a subsurface oil or gas reservoir or field. At step 202, a plurality of rock cores obtained from a plurality of wells drilled in the reservoir or field are analyzed. A plurality of well logs comprising a plurality of different well log types are analyzed at step 204, where the well logs have been obtained from the plurality of wells. On the basis of the foregoing rock core and well log analyses, at step 206 an initial depofacies classification for at least portions of the oil or gas reservoir or field is determined. At step 208, it is determined whether at least one diagenetic, heavy, light or anomalous mineral is present in at least some of the analyzed rock cores. If at least one diagenetic, heavy, light or anomalous mineral is detected in at least some of the analyzed rock cores at step 208, at step 210 at least one well log type from among the plurality of different well log types is selected or determined that is capable of substantially accurately identifying a presence of the at least one diagenetic, heavy, light or anomalous mineral in a well bore. The initial depofacies classification is then re-analyzed and reclassified at step 212 on the basis of the rock core analyses, the well log analyses, the diagenetic, heavy, light or anomalous mineral detection, and the at least one determined well log type to produce a refined depofacies classification for at least portions of the oil or gas reservoir or field.

Continuing to refer to FIG. 2, and as discussed in further detail below, it is to be noted that method 200 may further comprise one or more of: (a) using production data from the oil or gas field or reservoir as a further input to determining the initial depofacies classification or the refined depofacies classification; (b) generating a suite of synthetic petrophysical logs that explain observed hydrocarbon production across the oil or gas reservoir or field; (c) using the resulting suite of synthetic petrophysical logs to refine the depofacies classification; (d) determining a likely impact of the at least one diagenetic mineral, light mineral, heavy mineral, or anomalous mineral on hydrocarbon production in the reservoir or field and providing same as an additional input to the hydrocarbon production model; (e) developing an initial permeability model as an additional input to the hydrocarbon production model; (f) using at least portions of the refined depofacies classification to determine a lithofacies classification for at least portions of the oil or gas reservoir or field; (g) using at least some of the rock core analyses to determine a lithofacies classification for at least portions of the oil or gas reservoir or field; (g) adjusting the refined depofacies classification and the lithofacies classification using permeability profile production data obtained from the reservoir or field; (h) determining a Reservoir Quality Index (RQI) for the reservoir or field; (i) iterating and readjusting the refined depofacies classification on the basis of the RQI; (j) iterating and readjusting the lithofacies classification on the basis of the RQI; (k) reclassifying the rock cores on the basis of the refined depofacies classification; (l) resolution-matching the reclassified rock cores to the well logs to preserve heterogeneity and variability of reservoir properties associated with the oil or gas reservoir or field; (m) employing X-ray diffraction (XRD) to properly evaluate or identify lithology and mineralogy, and determine whether at least one diagenetic, heavy, light or anomalous mineral is present; (n) detecting, by way of example, at least one of albite or other feldspar, zircon, dolomite, iron carbonate and pyrite as the diagenetic, heavy, light or anomalous mineral; (o) providing a plurality of different well log types that include at least one of gamma ray (GR) logs, compensated formation density (RHOB) logs, neutron porosity (NPHI) logs, compressional wave sonic (DTC) logs, and shear wave sonic (DTS) logs; (p) resolution matching rock core analyses with well log analyses when determining the refined depofacies classification; (q) iterating and readjusting the refined depofacies classification on the basis of well log data; (r) employing sonic log data to construct velocity and anisotropy logs that may be input into an initial 3D seismic velocity model corresponding to at least portions of the reservoir or field; (s) employing sonic log data to readjust and iterate the refined depofacies classification; and (t) removing artifacts from at least some of the well logs on the basis of the resulting hydrocarbon production model.

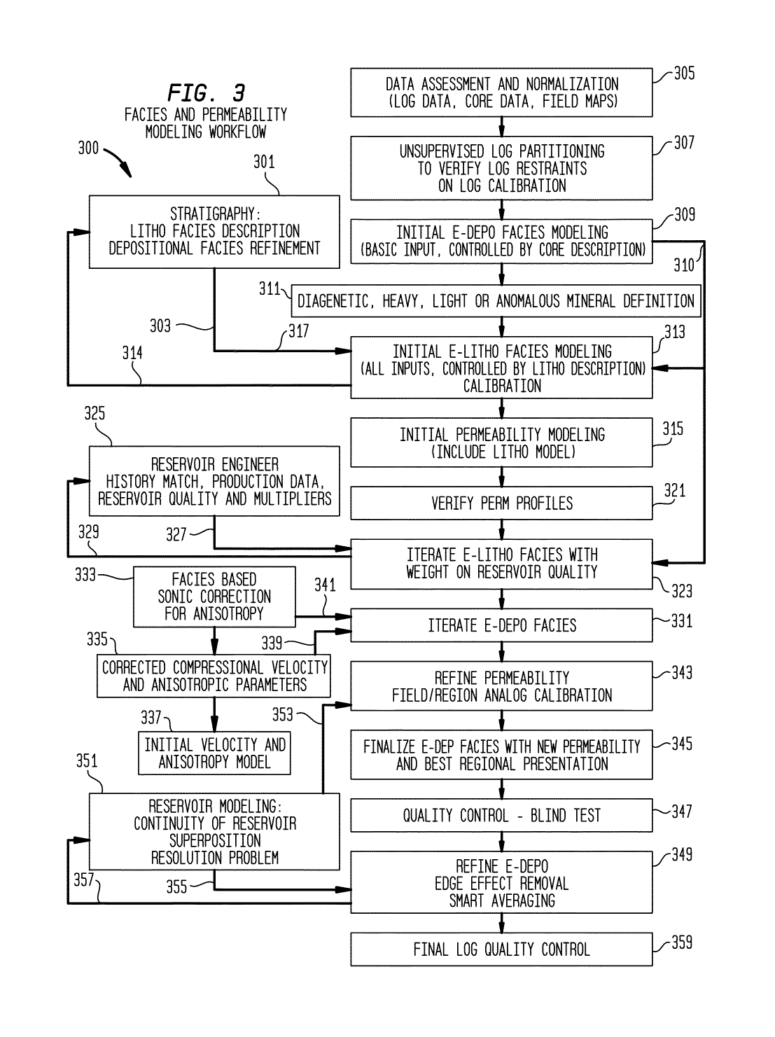

Referring now to FIG. 3, there is shown one embodiment of a detailed facies and permeability modeling workflow 300 for generating a refined depofacies classification corresponding to a subsurface oil or gas reservoir or field, and that further expands upon certain aspects of method 200 illustrated in FIG. 2. Method 300 of FIG. 3 may begin by assessing and normalizing data at step 305 that are available for the field or reservoir, such as well log data, rock core data, and field maps. As part of step 305, common logs may be identified to create a regional model, where logs that are reasonably consistent with one another are used for all wells. Wells with having routine core analyses and XRD mineralogy descriptions associated therewith can provide further input, as can core depositional facies descriptions. Rock cores representative of the field or reservoir, and that cover all the pertinent reservoir facies of the field, may be employed. In one embodiment, data from at least one cored well are left out of the training data set for later confirmation and blind test purposes. At this point in the workflow, sonic logs may also be corrected for anisotropy and for subsequent velocity modeling.

At step 307, facies modeling without rock core control or input (i.e., unsupervised log partitioning) is used to determine the restraints or limits that can be employed in log calibration, and to aid in determining the reliability of rock core descriptions that have been provided as inputs.

At step 309, an initial depositional facies (i.e., E-depo facies or output E_DEPO1, which is a petrophysical depositional facies) is generated using selected well logs including one or more of, but not necessarily limited to, gamma ray (e.g., GR), bulk density (e.g., RHOB), neutron porosity (e.g., NPHI) and compressional sonic log (e.g., DTC) well logs. The well logs may be controlled by corresponding rock core descriptions. As shown in FIG. 3, outputs from step 309 may be employed as inputs to steps 311, 313 and/or 323.

At step 311, the presence (or absence) of dolomite, heavy minerals, light minerals or anomalous minerals such as, by way of example, albite or other feldspars, pyrite, siderite or iron carbonate, or zircon in the initial depositional facies characterizing the reservoir or field is determined, as is the impact, positive or negative, of such heavy minerals on reservoir performance. Step 311 further includes identifying those well log types which are capable of detecting or recognizing accurately and reliably the presence of such heavy minerals.

At this point in the process or method, it may not be sufficient to employ interpreted depofacies descriptions, and thus the available interpreted depofacies descriptions may be combined with the lithofacies descriptions (which tend to be more robust) to produce refined and more accurate depofacies descriptions.

At step 301, lithofacies descriptions are generated, and depositional facies descriptions are refined, which serve as inputs 317 to step 313, where the initial E-depo facies produced at step 309 is calibrated. At step 301, E-lithofacies may be determined iteratively by referring to the lithofacies descriptions CORE_LITHO (which is a core lithological description), and also by referring to data from well logs such as neutron-density separation (NDS) well logs, and by referring to information regarding the amount of dolomite (VOL_DOLOMITE) that is present. Step 313 produces output E_LITHO1 (which is a petrophysical lithological facies). While these steps may improve the quality of the lithofacies description, and in particular the delineations of separations between facies, in many cases further work must generally be done to provide useful or accurate results.

At step 315, initial permeability modeling is carried out, where the lithofacies model from step 313 is employed as an input thereto. Initial permeability modeling at step 315 may include, by way of example, a multi-clustering approach employing well logs and the lithofacies determined at step 313. VOL_DOLOMITE, NDS and E_LITHO1 may be used as inputs to step 315. While permeability end points may improve substantially in step 315, important discrepancies between the generated data may yet remain. At step 321, permeability profiles generated in step 315 may be verified by rock core data and production profiles (when they are available). Note that steps 301 through 321 typically include integrating stratigraphic data with petrophysical data (see FIG. 1).

Referring still to FIG. 3, reservoir information and data such as reservoir history matches, reservoir production data, and reservoir quality from step 325 may be provided as inputs to step 323, where E-lithofacies data, by way of illustrative example, are iterated and weighted in accordance with one or more of reservoir quality index data, well logs such as NDS, and VOL_DOLOMITE to provide an output E-LITHO2.

At step 331, the E-depo facies is iterated using one or more of E-LITHO2, permeability data, old depositional interpretation data, and measured well logs to produce a revised E-depo facies output E_DEPO2. Note that E-LITHO2 and E_DEPO2 may be further refined by splitting and lumping the data associated therewith by using permeability profile production data as a discriminator of reservoir quality index (RQI).

An additional input to step 331 may be facies-based corrections for velocity anisotropy and velocity corrections, as shown in step 335 of FIG. 3. One or more of steps 333 and 335 of FIG. 3 may be employed to provide improved initial velocity inputs for corresponding 3D seismic velocity models. Steps 335 and 337 can include detailed sonic log conditioning, analysis of sonic log data coverage, estimation of seismic velocity anisotropy factors (e.g., determination of epsilon and delta seismic velocity anisotropy correction factors), ETA parameter definition, correction of seismic velocity anisotropy, seismic velocity and resolution averaging, and updating seismic velocity models by adjusting sonic well log data, maintaining stratigraphic details, preserving a geological layer cake model, and proper positioning of seismic velocities in the resulting 3D velocity model. Moreover, improved compressional and/or shear sonic log data can also be used to update facies corrections in step 331. New synthetic well log data correlations or ties may also be employed as inputs to the updated seismic velocity model for the field or reservoir. Quality control of updated seismic velocities may be provided at this point by referring to blind test data from a cored well.

At step 343, permeability predictions are refined using one or more new depositional logs in which updated reservoir continuity adjustments have been made that are stratigraphically accurate or consistent (and thus stratigraphically sound), and also using representative regional permeability data from adjoining or nearby fields or reservoirs. These steps help fill in data gaps and further improve permeability estimate predictions. The output of step 343 is PERMEABILITY_FINAL.

At step 345, a final E_DEPO facies model is generated using the permeability predictions and the regional data from step 343. The result of step 345 is E_DEPO_FINAL. Quality control of E_DEPO_FINAL may be provided by referring to blind test data. Note that steps 323 through 347 typically occur by integrating reservoir data with petrophysical data (see fields 106 and 108 in FIG. 1).

At step 349, E_DEPO_FINAL can be further refined by removing edge effects and artifacts from the depositional facies data, and by smart averaging the depositional facies data (which according to one embodiment involves removing artifacts produced by log resolution differences through assessing lithology flags and assigning proper facies at geological boundaries). Further inputs to steps 343 and 349 may be provided by step 351, where the stratigraphic continuity of depositional facies across multiple wells in the field or reservoir is analyzed using reservoir modeling techniques. Incompatible juxtapositions of depositional facies may then be identified and corrected using such stratigraphic continuity analyses, as can artifacts in depositional facies arising from well bore and modeling conditions. Final log quality control on the resulting depositional facies model can be applied at step 359.

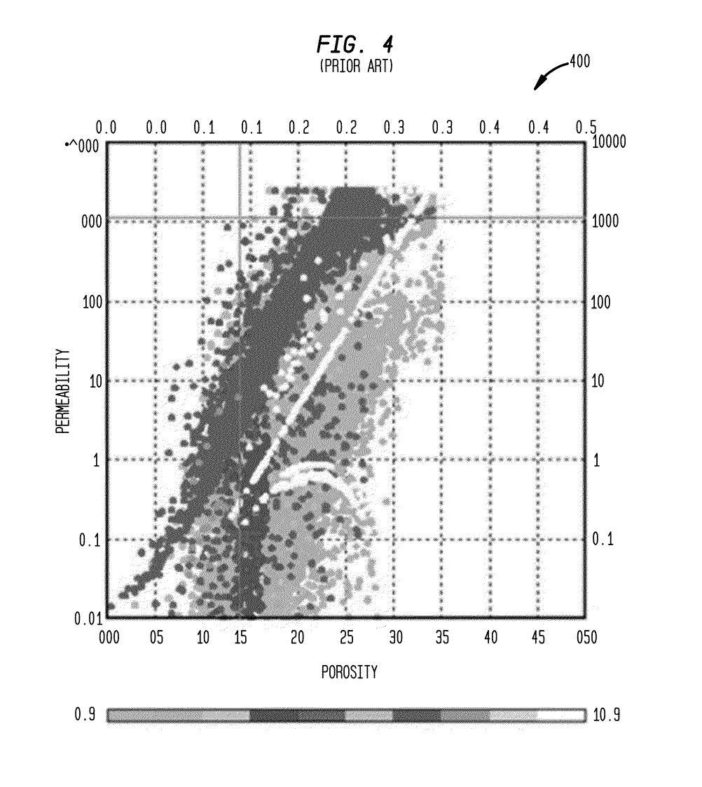

FIGS. 4 through 13 illustrate various aspects of some embodiments of the methods disclosed herein, including some of the steps described above in connection with method 200 of FIG. 2 and method 300 of FIG. 3.

FIG. 4 shows an exemplary porosity vs. permeability graph for a representative hydrocarbon reservoir or field. The graph of FIG. 4 was constructed in accordance with known prior art techniques using data from 30 wells drilled in the reservoir. Depositional facies, well log and rock core data were used to generate the cross-plot shown in FIG. 4. Depositional and lithological classifications were generated primarily using well log data, with the assistance of rock core data. In FIG. 4, tidal facies are shown with red data points, while shoreface facies are shown by orange data points. Permeability and porosity limits, and the limitations of the described depofacies, were necessarily employed to generate the cross-plot data of FIG. 4, which demonstrates the introduction of some undesired artifacts generated by the averaging of petrophysical properties, including, by way of example, large ranges of petrophysical properties where such ranges are not appropriate, and small ranges where one would expect to observe petrophysical heterogeneity. For example, reference to FIG. 4 shows that there exists a wide range and considerable overlap between the porosities and permeabilities associated with tidal facies and shoreface facies.

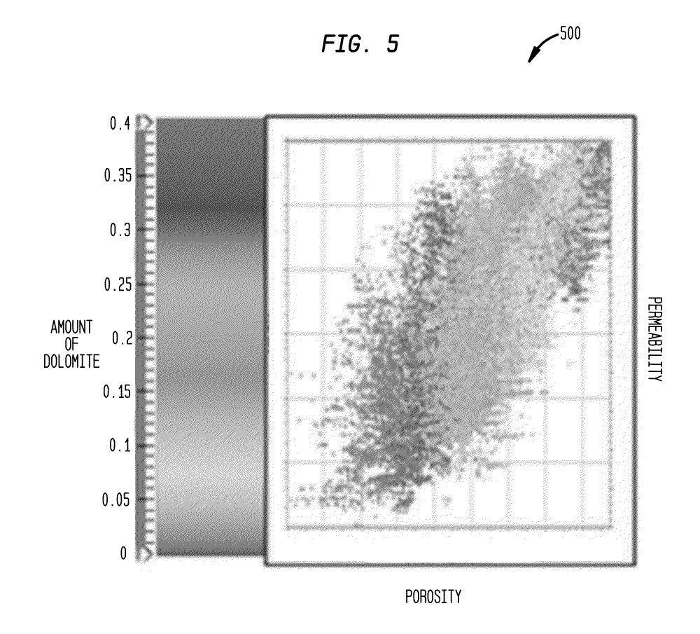

FIG. 5 shows dolomite content and porosity vs. permeability graph 500, and the effects of dolomite on porosity and permeability. Graph 500 was generated using data from the same 30 wells as in FIG. 4. The best reservoir rocks of FIG. 5 are represented by the red dots located at the upper right hand corner of FIG. 5, which correspond to shoreface facies. As illustrated in FIG. 5, these shoreface facies exhibit both high and moderate porosities and permeabilities. FIG. 5 shows that while higher dolomite content generally degrades porosity, increasing dolomite content does not necessarily degrade permeability. This runs counter to the conventional wisdom, which is that as dolomitization increases, porosity and permeability decrease (at least with respect to primary clastic reservoir rocks such as sandstone that have undergone diagenetic processes). As a result, it has been discovered that it is important to include dolomite content into facies modeling processes, more about which is said below.

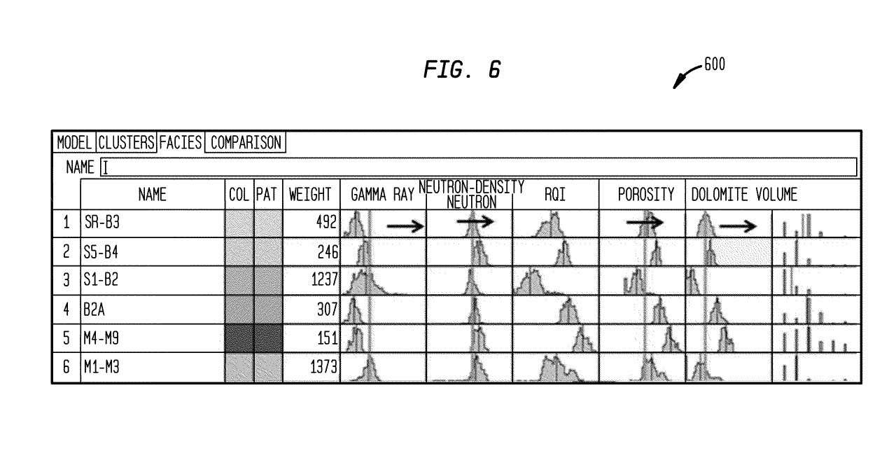

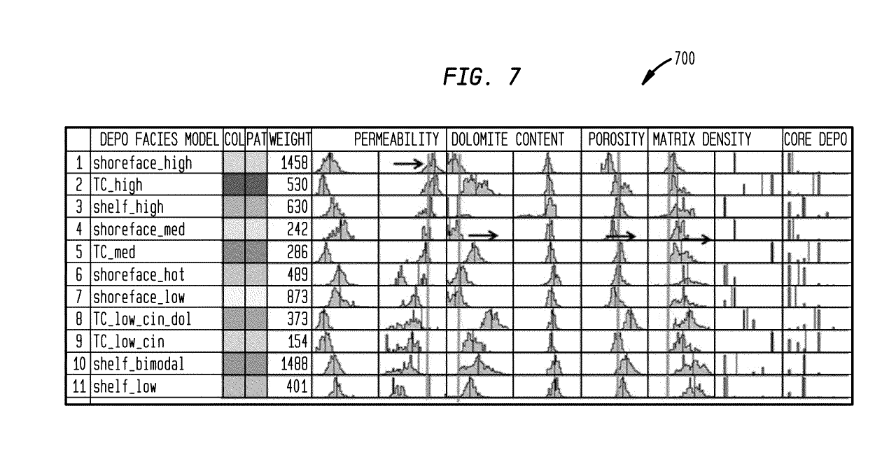

FIG. 6 shows a lithofacies model 600 based on data obtained from the same 30 wells as were employed to generate the porosity vs. permeability cross-plot of FIG. 4. Core data from 5 of the 30 wells was employed to generate FIG. 6. The vertical axis of FIG. 6 represents coarse-grained sandstone facies near the top, and finer muddier shales near the bottom, where M=mudstone, S=sandstone, and SR=stratified or bioturbated sandstone. As shown in FIG. 6, GR readings increase in the mudstones, and dolomite content increases generally in the mudstones. Also as shown in FIG. 6, lower dolomite content is associated generally with better reservoir characteristics. The lithofacies of FIG. 6 labelled “S1-B2” will be seen to possess the best reservoir characteristics owing perhaps to having the lowest dolomite content, and despite its heterogeneity, relatively low permeability and relatively high GR characteristics. According to one embodiment, FIG. 6 represents a step of defining an initial lithofacies for subsequent modeling steps and including Reservoir Quality Index (RQI) as an input to lithofacies determination. The lithofacies of FIG. 6 were used to build the initial permeability model of FIG. 7, and to serve as an input to subsequent depositional facies modeling and reconstruction.

FIG. 7 shows a depositional facies model 700 based on data obtained from the same 30 wells as were employed to generate the porosity vs. permeability cross-plot of FIG. 4, where the model was computed using the lithofacies of FIG. 6 and additional core data as inputs thereto so as to calculate initial permeability. The upper portions the vertical axis of FIG. 7 represent increased permeability, while the lower portions represent decreased permeability. Facies classification in FIG. 7 was improved by incorporating gamma ray well log responses and dolomite content. Reservoir engineering and production data were also used as inputs to the depositional facies model of FIG. 7, and included matrix density as a dolomite or diagenetic, heavy, light or anomalous mineral indicator, which provided an additional constraint for separation within the depositional facies. The depositional facies of FIG. 7 were successively iterated to better define diagenetic influences on rock quality. As described above in connection with FIG. 5, increased dolomite content changes the quality of reservoir rock and generally causes non-reservoir rocks to exhibit higher permeabilities.

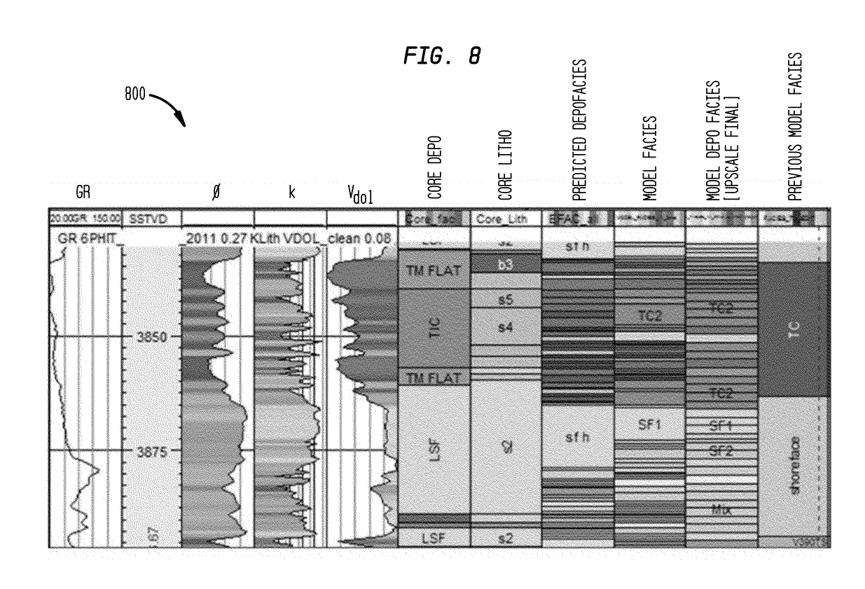

FIG. 8 shows the results of an iterative and geologically upscaled depositional facies model 800 generated using data corresponding to a single blind test well, as well as some of the results shown in FIGS. 5, 6 and 7. FIG. 8 shows that good matches to core descriptions and initial permeability are generated, which permits higher resolution and better geological continuity. Compare, for example, the previously-generated depositional facies shown on the far right-hand side of FIG. 8 to those shown just to the left thereof (which were calculated according to the new techniques described herein); a dramatic increase in facies resolution is shown to occur. Splitting depositional facies into smaller groups, as shown in FIG. 8, may be based at least partly on reservoir performance characteristics, and can provide significantly more robust inputs to a reservoir model.

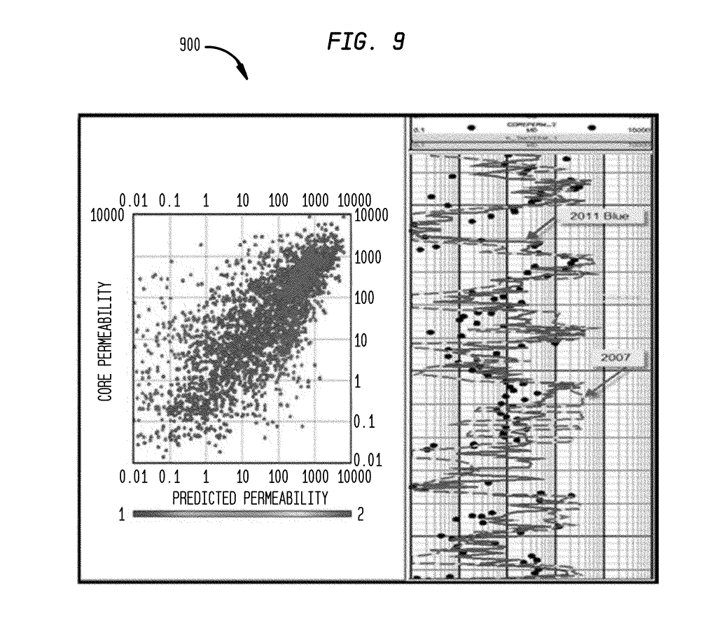

FIG. 9 shows results obtained for the blind test well of FIG. 8, where a new permeability model was constructed with improved depositional and lithofacies. On the left side of FIG. 9, core permeability measurements are cross-plotted against predicted permeabilities; red dots represent results computed in accordance with conventional modeling techniques, while blue dots represent results computed in accordance with the new modeling techniques described and disclosed herein. It will be seen that the scatter of predicted permeabilities shown in the graph on the left-hand side of FIG. 9 associated with the new techniques disclosed herein is significantly less than the scatter associated with conventional prior art techniques of predicting permeability.

On the right-hand side of FIG. 9, permeability data are shown as a function of well depth, where rock core permeability data are represented as black dots. The red curve represents a permeability curve generated using prior art techniques, and the blue curve represents predicted permeability data generated using the new techniques described herein. The graph on the right-hand side of FIG. 9 shows that predicted permeabilities computed in accordance with the new techniques described and disclosed herein provide improved matches to measured rock core permeabilities, and better represent reservoir facies, than do the conventionally-modelled predicted permeability data.

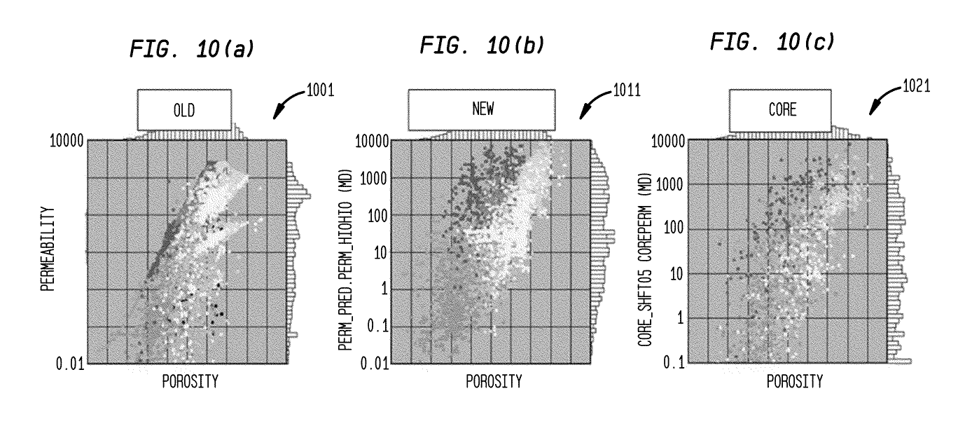

The results shown in FIG. 9 are further supported by reference to FIGS. 10(a), 10(b) and 10(c), which compare and contrast, respectively, “old,” “new” and core cross-plotted permeability vs. porosity data. Predicted permeability data computed in accordance with prior art techniques are shown in FIG. 10(a). Predicted permeability data computed in accordance with the new techniques described and disclosed herein are shown in FIG. 10(b). Porosity and permeability data measured in rock cores are shown in FIG. 10(c). Comparison of the data shown in FIG. 10(a) to that of FIG. 10(c), and of FIG. 10(b) to FIG. 10(c), shows that the new techniques described and disclosed herein yield significantly more reliable and accurate results, both with respect to facies prediction and permeability, and to significantly better matches to the rock cores.

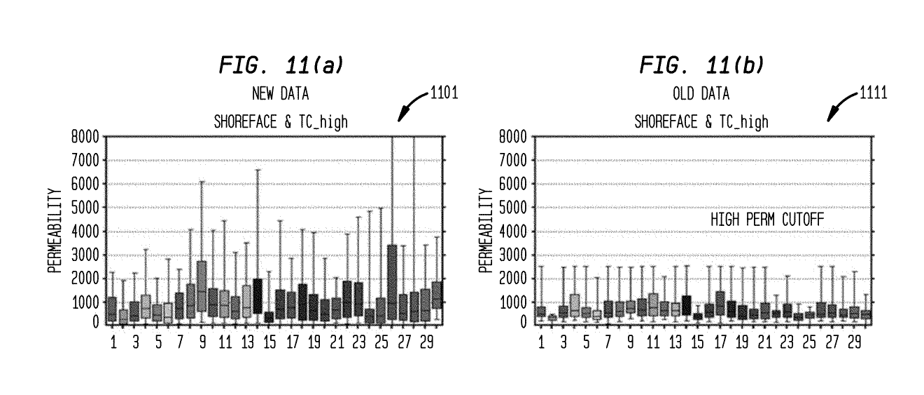

FIGS. 11(a) and 11(b) represent predicted ranges of permeability for the two best reservoir facies of the 30 wells described above in connection with FIGS. 4 through 10(c). FIG. 11(a) shows ranges of predicted permeability computed in accordance with the new techniques described and disclosed herein, while FIG. 11(b) shows ranges of predicted permeability computed in accordance with prior art techniques. The results of FIG. 11(a) demonstrate that while dolomitization and diagenesis affect both such formations significantly, well-sorted large grain formations with relatively low permeability, and heavily dolomitized smaller grain sand formations with increased permeability, can nevertheless serve as good reservoir rocks. Contrariwise, the results of FIG. 11(b) show that ranges of predicted permeability are much less than those shown in FIG. 11(a), and substantially less representative of actual permeabilities and well performance than those shown in FIG. 11(a). Multiple facies are typically drilled through and produced from in a well, thereby explaining the relatively wide range of permeabilities revealed by the present methods.

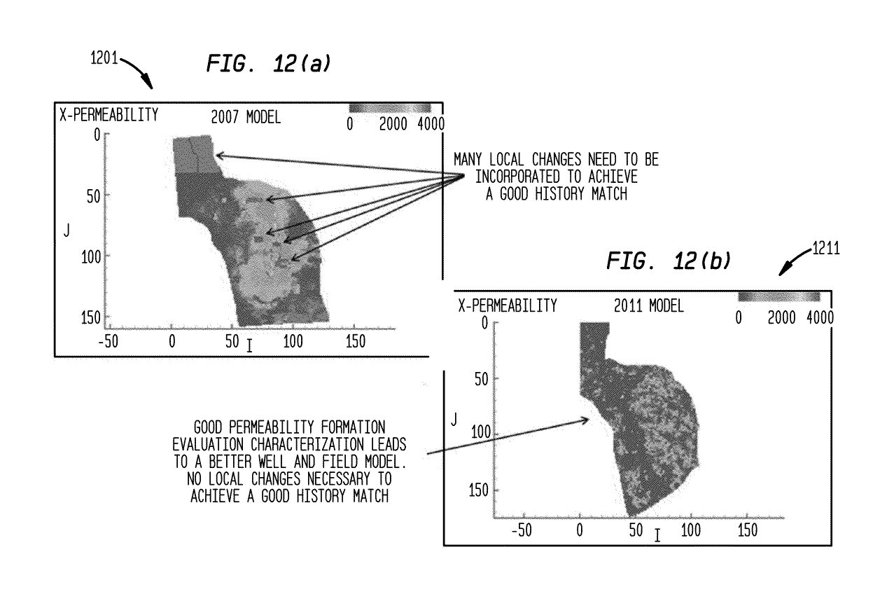

FIG. 12(a) shows predicted reservoir permeabilities across a representative field computed in accordance with conventional prior art techniques. FIG. 12(b) shows predicted reservoir permeabilities across the same field computed in accordance with the new techniques described and disclosed herein. Depositional facies represented in FIGS. 12(a) and 12(b) were developed using logs to create a depositional model that was distributed across a 3D domain. FIG. 12(a) shows that many local changes had to be incorporated into the old model to achieve a suitable match between reservoir production history data and predicted permeability data. In FIG. 12(b), no local changes had to be incorporated into the new model to achieve a good match between reservoir production history data and predicted permeability data. The model represented by FIG. 12(b) also exhibits improved stratigraphic continuity and facies distribution.

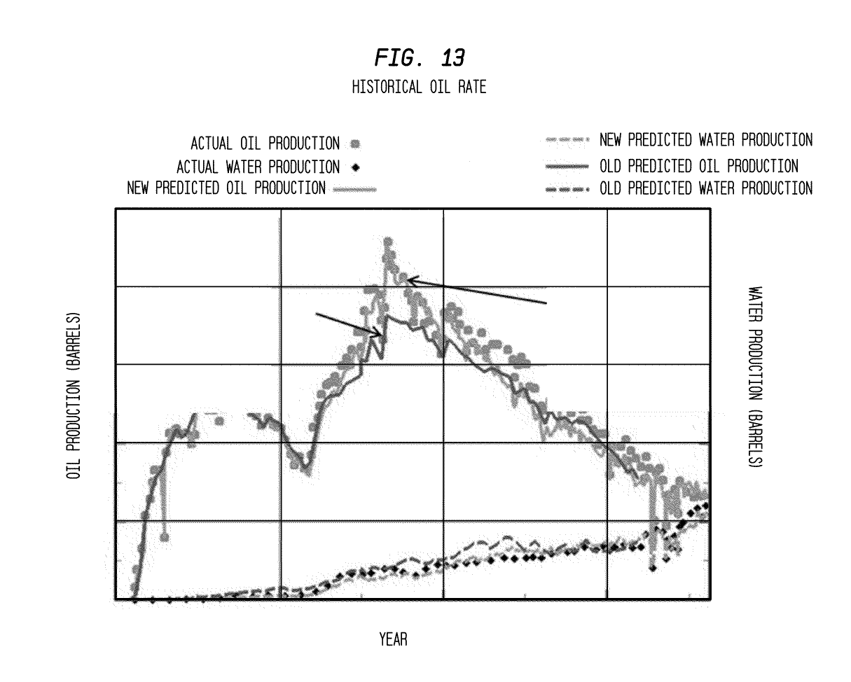

Referring now to FIG. 13, there are shown oil and water history production curves corresponding to the above-described field a representative field, where curves and dots computed in accordance with prior art techniques are shown in blue, those computed in accordance with the new techniques described and disclosed herein are shown in orange, and actual production data are shown in green. “Old” results shown in blue were computed using a flux well solution with multipliers, artificial local changes, and artificial fault leaks, and multipliers for production rates and artificial pressure adjustment were required to make the results conform as closely as possible to the actual production data. In contrast, the “new” results shown in orange were computed using a preliminary solution with new petrophysical modeling and no artificial fault openings or conduits, and further employed normal reservoir pressure data with no multipliers to adjust production rates. FIG. 13 shows that the new techniques described and disclosed herein provide substantially more accurate matches to actual oil and water production data than do prior art techniques.

The above-described methods may also be applied to fields or reservoirs where modern data such as image logs, NMRI logs, and spectral data logs have not historically been acquired, and where the log suites that have been acquired historically in the field are limited to basic suites of logs such as neutron density logs, gamma ray logs, acoustic logs and resistivity logs. The foregoing methods, employed in combination with older basic suites of logs, can produce improved models and better depofacies classifications.

The following printed publications provide further background information relating to the above-described techniques that those skilled in the art may find of interest: (1) “Using Seismic Facies to Constrain Electrofacies Distribution as an Approach to Reduce Spatial Uncertainties and Improve Reservoir Volume Estimation,” Ribet et al., Jul. 18, 2011, AAPG Search and Discovery Article #40768 (2011); (2) “A New Tool for ElectroFacies Analysis: Multi-Resolution Graph-Based Clustering,” Shin-Ju Ye et al., SPWLA 41^{st} Annual Logging Symposium, Jun. 4-7, 2000; (3) “Permeability Determination from Well Log Data,” Mohaghegh et al., SPE Formation Evaluation, September, 1997. Each of the foregoing printed publications is incorporated by reference herein, each in its respective entirety.

The above-described embodiments should be considered as examples of the various embodiments, rather than as limiting the respective scopes thereof. In addition to the foregoing embodiments, review of the detailed description and accompanying drawings will show that there are other embodiments. Accordingly, many combinations, permutations, variations and modifications of the foregoing embodiments not set forth explicitly herein will nevertheless fall within the scope of the various embodiments.

We claim:

1. A method of generating a depofacies classification corresponding to a subsurface oil or gas reservoir or field, comprising:
analyzing a plurality of rock cores obtained from a plurality of wells drilled in the reservoir or field;
analyzing a plurality of well logs comprising a plurality of different well log types, the well logs having been obtained from the plurality of wells;
on the basis of the rock core and well log analyses, determining an initial depofacies classification for at least portions of the oil or gas reservoir or field;
determining whether at least one diagenetic, heavy, light or anomalous mineral is present in at least some of the analyzed rock cores;
if at least one diagenetic, heavy, light or anomalous mineral is detected in at least some of the analyzed rock cores, determining at least one well log type from among the plurality of different well log types that capable of substantially accurately identifying a presence of the at least one diagenetic, heavy, light or anomalous mineral in a well bore, and
re-analyzing and reclassifying the initial depofacies classification on the basis of the rock core analyses, the well log analyses, the diagenetic, heavy, light or anomalous mineral detection, and the at least one determined well log type to generate a refined depofacies classification for at least portions of the oil or gas reservoir

2. The method of claim 1, further comprising using production data from the oil or gas field or reservoir as a further input to determining the initial depofacies classification or the refined depofacies classification.

3. The method of claim 1, further comprising generating a model of hydrocarbon production in the oil or gas reservoir or field using the refined depofacies classification as at least one input to the model.

4. The method of claim 3, further comprising determining a likely impact of the at least one diagenetic, heavy, light or anomalous mineral on hydrocarbon production in the reservoir or field and providing same as an additional input to the hydrocarbon production model.

5. The method of claim 3, further comprising developing an initial permeability model as an additional input to the hydrocarbon production model.

6. The method of claim 1, further comprising using at least portions of the refined depofacies classification to determine a lithofacies classification for at least portions of the oil or gas reservoir or field.

7. The method of claim 1, further comprising using at least some of the rock core analyses to determine a lithofacies classification for at least portions of the oil or gas reservoir or field.

8. The method of either of claims 6 and 7, further comprising adjusting the refined depofacies classification and the lithofacies classification using permeability profile production data obtained from the reservoir or field.

9. The method of claim 8, further comprising determining a Reservoir Quality Index (RQI) for the reservoir or field.

10. The method of claim 8, further comprising iterating and readjusting the refined depofacies classification on the basis of the RQI.

11. The method of claim 8, further comprising iterating and readjusting the lithofacies classification on the basis of the RQI.

12. The method of claim 1, further comprising reclassifying the rock cores on the basis of the refined depofacies classification.

13. The method of claim 12, further comprising resolution-matching the reclassified rock cores to the well logs to preserve heterogeneity and variability of reservoir properties associated with the oil or gas reservoir or field.

14. The method of claim 1, further comprising employing X-ray diffraction (XRD) to identify the at least one diagenetic, heavy, light or anomalous mineral.

15. The method of claim 1, wherein diagenetic, heavy, light or anomalous mineral detection further comprises detecting at least one of zircon, dolomite, iron carbonate, pyrite and albite.

16. The method of claim 1, wherein the plurality of different well log types includes at least one of gamma ray (GR) logs, compensated formation density (RHOB) logs, neutron porosity (NPHI) logs, compressional wave sonic (DTC) logs, and shear wave sonic (DTS) logs.

17. The method of claim 1, wherein determining the refined depofacies classification further comprises resolution matching rock core analyses with well log analyses.

18. The method of claim 1, further comprising iterating and readjusting the refined depofacies classification on the basis of well log data.

19. The method of claim 1, further comprising employing sonic log data to readjust and iterate the refined depofacies classification.

20. The method of claim 19, further comprising employing the sonic log data to construct an initial 3D seismic velocity model corresponding to at least portions of the reservoir or field.

21. The method of claim 19, further comprising employing the sonic log data to construct an initial 3D seismic velocity anisotropy model corresponding to at least portions of the reservoir or field.

22. The method of either claim 20 or 21, further comprising adjusting the sonic log data on the basis of at least one of the initial 3D seismic velocity model and the initial 3D seismic velocity anisotropy model.

23. The method of claim 1, further comprising removing artifacts from at least some of the well logs on the basis of the resulting hydrocarbon production model.
